(19) United States
(12) Patent Application Publication
(10) Pub. No.: US 2025/0186992 A1
(43) Pub. Date: Jun. 12, 2025

(54) CELL-ISOLATING DISPENSERS

(71) Applicant: Hewlett-Packard Development Company, L.P., Spring, TX (US)

(72) Inventors: Ken Ward, Corvallis, OR (US); Viktor Shkolnikov, San Jose, CA (US); Alexander Govyadinov, Corvallis, OR (US)

(73) Assignee: Hewlett-Packard Development Company, L.P., Spring, TX (US)

(21) Appl. No.: 18/848,888

(22) PCT Filed: Apr. 1, 2022
(86) PCT No.: PCT/US2022/022991

§ 371 Date: Sep. 19, 2024

(51) Int. Cl. B01L 3/02; G01N 15/10; G01N 15/1434; G01N 15/149

(52) U.S. Cl. CPC B01L 3/0268; G01N 15/1436; G01N 15/149; B01L 2200/0652; B01L 2300/0654; B01L 2300/0829; B01L 2400/02; B01L 2400/0442; G01N 2015/1006

(57) ABSTRACT

A cell-isolating dispenser can include a fluid reservoir, a foyer, and a thermal ejector. The foyer can be fluidically coupled via a fluid outlet to the fluid reservoir. The foyer is configured to receive a cell-containing fluid from the fluid reservoir and has a wall that is optically transparent or a portion of a wall that is optically transparent. The thermal ejector is fluidically coupled to the foyer to receive the cell-containing fluid from the foyer and operable to thermally eject a droplet of the cell-containing fluid through a nozzle via a thermal actuator.

### BACKGROUND

Separation of particles, specifically cell sorting, can be beneficial for use in various industries, particularly in the fields of biology and medicine. Cells, for example, can interact with fluorescent antibodies that may be specific to antigens on a cell surface, and antigens that correspond to specific markers tend to correspond to specific cell phenotypes. In further detail, cell sorting can be carried out using fluorescence-activated cell sorting (FACS) machines, which typically utilize focused sheathed flow in a quartz cuvette or other similar flow cell, confine the cells in droplets, and deflect the droplets using electric fields based on the fluorescence response of the droplet. Such systems are typically slow and expensive to use due to specialized fluidics and electrical actuation.

### BRIEF DESCRIPTION OF THE DRAWINGS

FIG. 1 is a schematic illustration of an example cell-isolating dispenser in accordance with the present disclosure;

FIG. 2 is a schematic illustration of another example cell-isolating dispenser in accordance with the present disclosure;

FIG. 3 is a schematic illustration of another example cell-isolating dispenser in accordance with the present disclosure;

FIG. 4 is a schematic illustration of an example cell-isolating dispensing system in accordance with the present disclosure;

FIG. 5 is a schematic illustration of another example cell-isolating dispensing system in accordance with the present disclosure; and

FIG. 6 is a flow diagram illustration of an example method of isolating and sorting individual cells.

### DETAILED DESCRIPTION

In a biological sample, a cell of interest can be intermixed with other cells and components. These other cells and components can interfere with a subsequent analysis of the cell of interest. Isolating the cell of interest from other cells and components of the biological sample can permit subsequent analysis without interference, can increase an accuracy of the subsequent analysis, and can permit analysis of the cell of interest that may not be possible if the other cells and components remained in the biological sample. Many of the current isolation techniques can include repeatedly dispersing and re-aggregating samples. The repeated dispersing and re-aggregating can result in a loss of a quantity of the cells of interest, can be complex, time consuming, labor intensive, and costly.

In accordance with examples of the present disclosure, cell-isolating dispensers can include a fluid reservoir, a foyer fluidically coupled to the fluid reservoir via a fluid outlet to receive a cell-containing fluid from the fluid reservoir, and a thermal ejector fluidically coupled to the foyer. A wall (from any orientation, e.g., side wall, lower wall or floor, etc.) of the foyer or a portion of the wall in this example is optically transparent. The thermal ejector is included to receive the cell-containing fluid from the foyer and thermally eject a droplet of the cell-containing fluid through a nozzle via a thermal actuator. In some examples, the optically transparent wall or optically transparent portion thereof can form a collimating lens or can include a collimating lens attached thereto. The collimating lens can be refractive, Fresnel, or diffractive. In some examples, where a diffractive lens is used, a shape of a diffractive element of the lens can be brazed, saw-tooth, amplitude, binary, quaternary, or sinusoidal. In other examples, the lens can be a gradient refractive index lens. Gradient refractive index optics can focus light the same way as a conventional lens; however light rays are not bent at the lens surface, rather light rays are continuously bent within the lens until the rays become focused, such as at one location. The foyer can also be partially defined by an opposing or transverse wall (relative to the optically transparent wall or wall with an optically transparent portion) that includes an optical detector. An opposing wall as defined herein is a wall that is located across from the optically transparent wall. A traverse wall is defined as a wall that is located along a plane that transects a plane of the optically transparent wall, e.g., a perpendicular. Accordingly, an optical detector can be located with respect to the optically transparent wall such that a light beam passes through the optically transparent wall onto the optical detector or to an element capable of directing the light beam to the optical detector. In an example, an optical detector can include a band pass filter and a p-n junction diode. A band pass filter passes frequencies in a certain range while attenuating frequencies outside that range. A p-n junction diode is a two-terminal semiconductor capable of converting light into an electrical current when photons are absorbed in the photodiode. In other examples, the cell-isolating dispenser can include an impedance sensor to measure impedance and monitor passage of a cell in the cell-containing fluid through the cell-isolating dispenser. The fluid outlet can include a constricted region and the impedance sensor can be positioned to measure impedance at the constricted region. In some examples, the nozzle can be configured to eject the droplet of the cell-containing fluid at a droplet size from 15 μm to 50 μm.

In other examples, cell-isolating systems can include a cell-isolating dispenser including a fluid reservoir, and a foyer fluidically coupled to the fluid reservoir via a fluid outlet, the foyer to receive a cell-containing fluid from the fluid reservoir, wherein a wall or portion of the wall of the foyer is optically transparent. The cell-isolating dispenser can also include a thermal ejector fluidically coupled to the foyer to receive the cell-containing fluid from the foyer and thermally eject a droplet of the cell-containing fluid through a nozzle via a thermal actuator. The cell-isolating systems can also include an illumination source to emit light towards the wall or portion of the wall that is optically transparent and can further include a detector to detect fluorescence emitted from a fluorescent molecule conjugated with a cell in the cell-containing fluid. In some examples, the cell-isolating systems can include an optical filter, beam splitter, mirror, or a prism to isolate and direct filtered wavelengths of light. In other examples, the systems can include a stage configured to accept a multi-well plate. The stage and the cell-isolating dispenser can be movable in relation to one another in order to align individual wells of a well plate with the nozzle of the thermal ejector. In some examples, the systems can further include a controller to expel fluid from the foyer though the nozzle, align individual wells of a well plate with the nozzle of the thermal ejector, set a vertical distance between a fluid in a multi-well plate and the nozzle of the thermal ejector, or a combination thereof.

In other examples, methods of isolating and sorting individual cells can include loading a cell-containing fluid including a cell conjugated with a fluorescent molecule into a cell-isolating dispenser and emitting light towards or from the cell-isolating dispenser (depending on where a detector is located, e.g., on chip or off chip). The cell-isolating dispenser in this example includes a fluid reservoir, and a foyer fluidically coupled to the fluid reservoir via a fluid outlet, the foyer to receive a cell-containing fluid from the fluid reservoir, wherein a wall or portion of the wall of the foyer is optically transparent. The cell-isolating dispenser can also include a thermal ejector fluidically coupled to the foyer to receive the cell-containing fluid from the foyer and thermally eject a droplet of the cell-containing fluid through a nozzle via a thermal actuator. The methods can also include optically detecting the cell conjugated with the fluorescent molecule in the foyer based on emitted fluorescence through the wall or portion of the wall that is optically transparent and ejecting the droplet of the cell-containing fluid including the cell conjugated with the fluorescent molecule from the nozzle of the thermal ejector into a multi-well plate. In some examples, the droplet of the cell-containing fluid can include a fluorescing cell that is individually ejected into individual wells on the multi-well plate. Notably, however, in some examples both tagged and untagged cells can be ejected with their ejection location in a well plate known to be either of interest or not. The methods can also further include determining a cell type of the fluorescing cell in the individual wells on the multi-well plate. In other examples, a cell type of a fluorescing cell can be determined based on the emitted fluorescence through the wall or portion of the wall that is optically transparent. The methods can also include emitting fluorescing cells of interest into individual wells on the multi-well plate, and the fluorescing cells that are not of interest can be ejected into a communal junk well.

Terms used herein will have the ordinary meaning in their technical field unless specified otherwise. In some instances, there are terms defined more specifically throughout the specification or in this section of the present specification, and thus, these terms can have a meaning as described herein.

When discussing cell-isolating dispensers, cell-isolating systems, and methods of isolating and sorting individual cells, these discussions can be considered applicable to one another whether or not they are explicitly discussed in the context of that example. Thus, for example, when discussing a foyer related to the cell-isolating dispenser, such disclosure is also relevant to and directly supported in the context of the cell-isolating systems, the methods of isolating and sorting individual cells, and/or vice versa.

### Cell-Isolating Dispensers

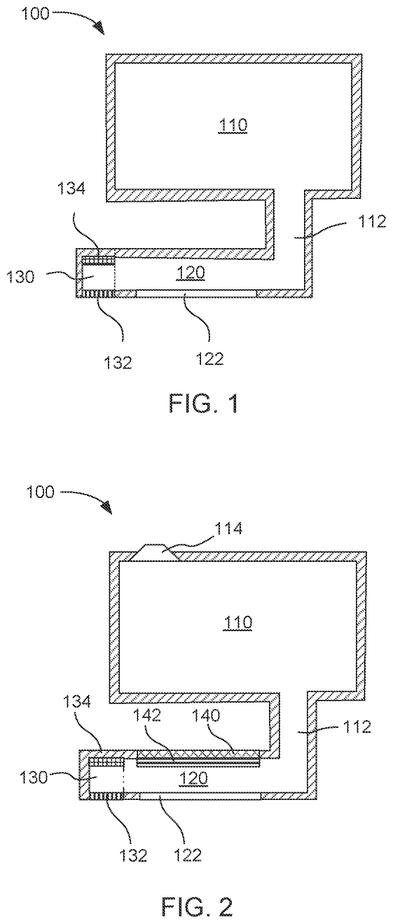

As illustrated in FIG. 1, a cell-isolating dispenser 100 can include a fluid reservoir 110, a foyer 120, and a thermal ejector 130. The fluid reservoir can receive a cell-containing fluid and can be fluidically coupled to the foyer via a fluid outlet 112. The foyer in this example includes an optically transparent wall 122 or a portion of the wall that is optically transparent. The thermal ejector is fluidically coupled to the foyer and is operable to thermally eject a droplet of the cell-containing fluid through a nozzle 132 via a thermal actuator 134.

As illustrated in FIG. 2, a cell-isolating dispenser 100 can include a fluid reservoir 110 with a fluid inlet 114. A fluid outlet 112 can fluidically connect the fluid reservoir to a foyer 120 that includes a wall (or portion thereof) 122 that is optically transparent. The foyer can be defined by another wall that includes an optical detector 140 optically coupled to an optical filter 142. The optical detector can be associated with a wall opposite the transparent wall (or portion thereof) or can be located on a transverse wall relative to the wall that is optically transparent. As mentioned, a traverse wall is defined as a wall that is located along a plane that transects a plane of the optically transparent wall, e.g., a perpendicular. In some examples, the dispenser can include a light directing element which can direct light towards the transverse wall. The optical detector in some examples can include a band pass filter and a p-n junction diode, camera detector, CCD detector, or CMOS detector, which may be positioned on an opposing wall or a traverse wall relative to the optically transparent wall or portion thereof. A thermal ejector 130 including a nozzle 132 and a thermal actuator 134 can be fluidically coupled to the foyer, as shown.

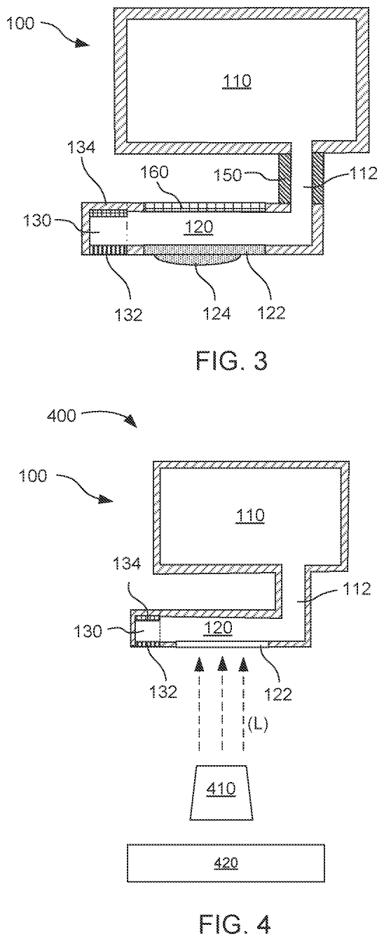

As shown by way of example in FIG. 3, an alternative cell-isolating dispenser 100 can include a fluid reservoir 110, a fluid outlet 112, a foyer 120, a wall (or portion thereof) 122 that is optically transparent, and a thermal ejector 130 including a nozzle 132 and a thermal actuator 134 fluidically coupled to the foyer, similar to that shown in previous examples. However, in this example, the wall that is optically transparent can be optically coupled to a collimating lens 124. Furthermore, the fluid outlet may include an impedance sensor 150 that can detect impedance as fluid passes there through. The foyer can also include a wall associated with a photo sensor 160, for example.

The term “cell-isolating dispenser” refers to dispensers that can isolate a single cell for dispensing. Thus, a cell-isolating dispenser could be referred to as a “single cell dispenser” or an “individual cell dispenser.” To be clear, the cell-isolating dispenser can dispense many cells on an individual cell basis. In some instances, a droplet of cell-containing fluid may include multiple cells and/or no cells, which may be detected and discarded where only single cell samples are desired for dispensing.

Referring now collectively to FIGS. 1-3, as shown in some examples, the fluid reservoir 110 can be associated with a fluid inlet 114. When included, the fluid inlet can have an opening, or an opening with a cover thereon, or can be constructed from a puncturable material to permit loading of a cell-containing fluid to the fluid reservoir. It is noted that the terms “inlet” and “outlet” do not infer that an opening interacts in one direction, though that could be the case. In some instances, there can be an occasion for the fluid to flow “backwards” or “bi-directionally,” and thus the terms “inlet” and “outlet” can be used because at some point during operation, these openings act as inflow of fluid and outflow of fluid, respectively, relative to the fluid reservoir and/or foyer.

The fluid reservoir 110, in further detail, can be sized and shaped to hold the cell-containing fluid. In some examples, the fluid reservoir can hold the bulk of the sample while a smaller portion of the sample flows through the fluid outlet and foyer. In some examples, the fluid reservoir can hold a volume of the cell-containing fluid ranging from 1 μL to 10 mL. In other examples, the fluid reservoir can hold a volume of the cell-containing fluid ranging from 10 μL to 10 mL, from 10 μL to 500 μL, from 200 μL to 800 μL, from 500 μL to 1 mL, from 1 mL to 10 mL, from 2 mL to 10 mL, from 2 mL to 4 mL, or from 3 mL to 10 mL. In some examples the fluid reservoir can have a height and length ranging from 1 mm×1 mm to 10 mm×10 mm, or from 2 mm×2 mm to 8 mm×8 mm. In yet other examples, the fluid reservoir can have a width ranging from 0.3 mm to 5 mm, from 0.5 mm to 2.5 mm, from 0.5 mm to 2.5 mm, from 1 mm to 5 mm, from 1 mm to 3 mm, or from 2 mm to 4 mm. The fluid reservoir can have a cross-sectional area larger than a cross-sectional area of the fluid outlet.

The fluid reservoir 110 can be fluidically coupled to the foyer 120 by a fluid outlet 112, which can be defined in some examples by a constricted region, e.g. a smaller cross-sectional average width (perpendicular to fluid flow), referred to hereinafter as “cross-sectional width” rather than the cross-sectional width of other adjoining volumes, e.g., the fluid reservoir and/or the foyer. In some examples, a cross-sectional width of the fluid outlet can be from 5 μm to 500 μm, from 10 μm to 500 μm, from 10 μm to 50 μm, from 25 μm to 75 μm, from 50 μm to 100 μm, from 100 μm to 300 μm, or from 250 μm to 500 μm. The cross-sectional width, in some examples, can be sized to permit passage of a single cell there through. The fluid outlet can be an opening between the fluid reservoir and the foyer. In other examples, a fluid outlet can be a channel extending between the fluid reservoir and the foyer. In some examples, the fluid outlet can include a constricted region and an impedance sensor can be positioned to measure impedance at the constricted region. In some examples, the fluid outlet can include a valve, closable flap, or another structure that can seal off the foyer from the fluid reservoir in order to selectively time load a portion of the cell-containing fluid into the foyer.

The foyer 120 can be sized and shaped to receive a cell-containing fluid from the fluid reservoir 110. The foyer can be configured as a linear microfluidic channel. A cross-sectional width of the foyer can be from 10 μm to 500 μm, from 10 μm to 50 μm, from 25 μm to 150 μm, from 50 μm to 200 μm, from 100 μm to 500 μm, or from 250 μm to 500 μm. A length of the foyer can be, for example, from 200 μm to 1,200 μm, from 200 μm to 300 μm, from 250 μm to 500 μm, from 250 μm to 650 μm, from 500 μm to 1,000 μm, from 700 μm to 1,200 μm, or from 900 μm to 1,200 μm. The foyer can allow for passage of a cell-containing fluid there through, and in some examples, can allow for the identification and/or location of a cell as the cell passes through the foyer. In some examples, the foyer can be further configured to allow for an identification of a type of cell as a cell passes through the foyer.

In some examples, the wall or portion thereof 122 that is optically transparent can be referred to herein alternatively as “optically transparent wall,” which includes examples where the entire wall is optically transparent or where a portion of the wall is optically transparent. Furthermore, the term “optically transparent” indicates that a material of the wall (or a portion) is of a material that permits at least 90% of a wavelength of light within an emission range of a light source or a detection range of an optical detector to pass through the optically transparent area. The optically transparent wall can be on the same side of the foyer as the thermal ejector, or on a different wall. For example, the optically transparent wall may be located on a side of the foyer that is a 90° angle from a nozzle of the thermal ejector. In some examples, the foyer can be constructed from an optically transparent material and the foyer can be side illuminated. The optically transparent wall or portion thereof can permit detection of a cell passing there through by allowing an excitation light to enter the foyer and excite a fluorescent molecule conjugated with a cell. Based on a fluorescence emission, a cell type of the cell passing there through can be determined.

The optically transparent wall 122 can form a collimating lens 124 or the optically transparent wall can have a collimating lens attached thereto. The collimating lens can narrow and focus light towards a specific direction. In some examples, the collimating lens can filter out light rays which are not traveling parallel to the direction of light rays that pass through the collimating lens. In an example, the collimating lens can be a refractive lens, a Fresnel lens, or a diffractive lens. A refractive lens bends light rays. A Fresnel lens is a specific type of composite compact lens having a large aperture and short focal length. Fresnel lenses can be thinner than comparable conventional lenses. A diffractive lens has thin elements that can make use of the wave nature of light. Diffractive lenses modify the phase of light using micro structure patterns fabricated on a surface of the lens. Light that passes through sunken areas travels faster than light that travels through higher areas of the lens creating controlled phase delay. In some examples, the collimating lens can be a lens that is refractive, brazed, saw-tooth, amplitude, binary, quaternary, or sinusoidal. A refractive lens can allow for from 95% to 100% collimation when fabricated using gray scale lithography and polishing. In an example, a refractive lens can be a gradient refractive lens. A blazed lens can allow for 90% to 100% collimation when fabricated using gray scale lithography and diamond turning. A saw-tooth lens can allow for 85% to 90% collimation when fabricated by diamond turning. An amplitude lens can allow for from 8% to 10% collimation when fabricated using conventional lithography. A binary lens can allow for from 35% to 40% collimation when fabricated using conventional lithography. A quaternary lens can allow for 70% to 85% collimation when fabricated using conventional lithography. A sinusoidal lens can allow for from 25% to 35% collimation when fabricated using holographic exposure. The collimating lens can direct light into the foyer.

In an example, a second wall, which can be positioned transverse or opposite the optically transparent wall that also defines the foyer 120, can include an optical detector 140. The term “defines” is inclusive of examples where the wall partially or fully defines the foyer. A component attached to or embedded in a wall can likewise partially define the foyer, e.g., recessed or partially recessed optical detector or other component. The optical detector can be positioned to receive fluorescent emissions. In some examples the optical detector can include a pin-photodiode, an avalanche photodiode, a phototransistor, a multi-junction photodiode, a charge coupling device, a complimentary metal-oxide semiconductor, a photo-sensor, an image sensor, a photo-resistor, a pyroelectric detector, a thermopile, a CMOS image sensor, a charge coupling device (CCD) image sensor, or a combination thereof. In other examples, the optical detector can include a pin-photodiode. In some examples, the optical sensor can include a multi-junction photodiode. In other examples, the optical sensor can include a camera sensor. In other examples, the optical detector can include a CMOS image sensor. In a further example, the optical detector can include a charge coupling device (CCD) image sensor. In some examples, the optical detector can be coupled with an optical filter, such as a band pass filter. The optical filter can be positioned between the optical detector and a cross-sectional opening of the foyer.

A thermal ejector 130 can be fluidically coupled to the foyer to receive the cell-containing fluid from the foyer. The thermal ejector can include thermal inkjet technology or similar thermal ejection technology. The thermal ejector can eject a droplet of the cell-containing fluid through a nozzle 132 via actuation using a thermal actuator 134, which may be positioned across from the nozzle or anywhere else suitable for generating a thermal bubble to eject fluid through the nozzle. More specifically, to eject a droplet of cell-containing fluid, the actuator can produce a vapour bubble that creates fluid displacement at the nozzle, and thus, ejects fluid from the thermal ejector that is supplied by the foyer 120. The actuator can be activated multiple times in order to expel a droplet of the cell-containing fluid out from the nozzle. In an example, the nozzle can be configured to eject a droplet including a single cell of the cell-containing fluid. The nozzle can be sized and shaped such that a surface tension of the fluid prevents the fluid from being expelled by gravitational forces while allowing for a predetermined sized droplet to be expelled. For example, the nozzle can be sized to expel a droplet of the cell-containing fluid at a size ranging from 15 μm to 50 μm. In yet other examples, the nozzle can be configured to eject the droplet of the cell-containing fluid at a size ranging from 20 μm to 40 μm, or from 25 μm to 35 μm. These droplet sizes are based on diameter or equivalent diameter of a volume where the droplet is not spherical.

In some examples, the cell-isolating dispenser 100 can further include a sensor or multiple sensors, either at a constricted region at the fluid outlet 112 and/or across from the optically transparent wall 122. For example, a sensor, such as a chemical sensor or an impedance sensor 150, can be positioned in a constricted region of the fluid outlet to monitor passage of particles of interest from the fluid reservoir to the foyer. In another example, an optical sensor 140, such as a photo sensor (with or without an optical filter 142), can be positioned at a location defining the foyer to monitor passage of a particle of interest there through. These sensors can be operable to detect a property of the cell-containing fluid flowing through the dispenser.

Referring more specifically to the impedance sensor 150, this sensor can detect a presence of a particle of interest, such as a cell in a cell-containing fluid, by measuring impedance changes as the cell-containing fluid passes there through. The impedance sensor can be formed using semiconductor fabrication techniques and can include alternating current (AC) or direct current (DC) sensing and can include metal electrodes that can create an electrical field with a flow way there through. As a cell-containing fluid flows between the electrodes, changes in the electrical field can indicate the passage of a particle of interest through the electric field. In some examples, the change in impedance can vary upon the type of the cell and can be correlated with cell type. For example, a first change in impedance can correlate to a first cell type and a second change in impedance can correlate to a second cell type.

In some examples, the sensor used can be an optical sensor 140, such as a photodetector or photoelectric sensor. The photo sensor can include an emitter and a receiver. The emitter can emit light to be received by the receiver. In some examples, a photoelectric sensor can have a through-beam arrangement where the emitter and the receiver are positioned on opposite sides of a flow way. In yet other examples, a photoelectric sensor can have a retroreflective arrangement where the emitter and the receiver can be positioned on the same side of a flow way and a reflector can reflect and/or direct light to the photoelectric sensor. An interruption in the light detected by the photoelectric sensor can evidence passage of a particle of interest.

In some examples, the cell-isolating dispenser 100 can include a plurality of components combined in ways not shown specifically in FIGS. 1-3, as any of the components shown can be combined as may be desired for a given application. In other examples, the cell-isolating dispenser can include a single fluid reservoir with multiple fluid outlets, foyers, and thermal ejectors fluidically connected to the fluid reservoir. In other examples, the cell-isolating dispenser can include multiple fluid reservoirs, fluid outlets, foyers, and thermal ejectors. A cell-isolating dispenser with a plurality of components can allow for sorting of multiple cell types at the same time. When sorting multiple cell types, differing cell types in the cell-containing fluid can be conjugated with differing fluorescent molecules. For example, cell A can be conjugated with fluorescent molecule A and cell B can be conjugated with fluorescent molecule B, and the cell-isolating can be configured to handle and dispense both types of conjugates separately.

The cell-isolating dispenser 100 can be fabricated using integrated circuit microfabrication techniques such as electroforming, laser ablation, anisotropic etching, sputtering, dry etching, wet etching, photolithography, casting, moulding, stamping, machining, spin coating, laminating, and the like. The cell-isolating dispenser can be manufactured from a variety of substrate materials. For example, the cell-isolating dispenser can include a material selected from glass, quartz, polyamide, polydimethylsiloxane, silicon, SU8, polystyrene, polycarbonate, polymethyl methacrylate, polyethylene, poly (ethylene glycol) diacrylate, polypropylene, perfluoroalkoxy, fluorinated ethylene propylene, polyurethane, cyclic olefin polymer, cyclic olefin copolymer, phenolics, or a combination thereof. In an example, the cell-isolating dispenser can be fabricated from polydimethylsiloxane. In another example, the cell-isolating dispenser can be fabricated from polycarbonate. In yet another example, the cell-isolating dispenser can be fabricated from silicon. In a further example, the cell-isolating dispenser can be fabricated from SU8.

### Cell-Isolating Systems

In accordance with examples herein, cell-isolating systems 400 are illustrated by way of example in FIG. 4. The cell-isolating system can include one or more cell-isolating dispenser(s) 100, an illumination source 410, and a detector 420. The cell-isolating dispenser can include a fluid reservoir 110 fluidically coupled to a foyer 120, such as via a fluid outlet 112. The foyer 120 can be defined in part by an optically transport wall 122. A thermal ejector 130 can be fluidly coupled to the foyer and can include a nozzle 132 and a thermal actuator 134. The various sensors shown in FIGS. 1-3 can be selected for use by way of example, and/or can include any of the other details described therein. The illumination source 410 can be positioned to emit or reflect light (L) towards a wall or portion thereof that is optically transparent, and which defines in part the foyer. A detector 420 can detect fluorescence emitted from a fluorescent molecule conjugated with a cell in the cell-containing fluid.

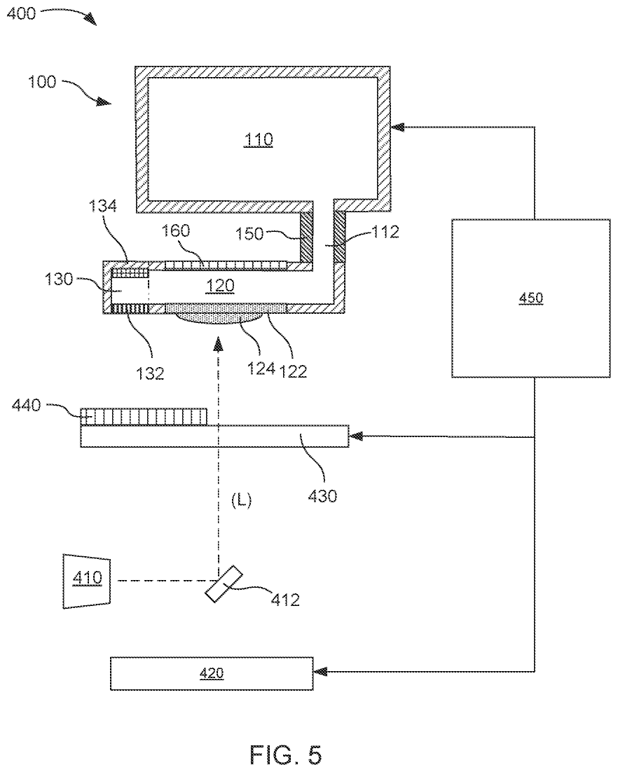

In further detail as shown in FIG. 5, alternative cell-isolating systems 400 are illustrated by way of example with the features shown in FIG. 4 and can further include a controller 450. This example system is also shown to include a cell-isolating dispenser 100, an illumination source 410, a mirror 412, a detector 420, a stage 430, and a multi-well plate 440 positioned on the stage. The cell-isolating dispenser includes some of the features shown in FIGS. 1-4, and again these components can be substituted or included with one another as may be desired for a specific application. In the example shown, a cell-isolating detector 100 is present and includes a fluid reservoir 110, a fluid outlet 112, a foyer 120, an optically transport wall 122, a collimating lens 124, a thermal ejector 130, a nozzle 132, a thermal actuator 134, and an impedance sensor 150. The illumination source 410 can be positioned such that light (L) is emitted or reflected towards the optically transparent wall or portion thereof of the cell-isolating dispenser.

The illumination source 410, in further detail, can emit electromagnetic energy. In some examples, the electromagnetic energy can excite a fluorescent molecule conjugated with a cell in the cell-containing fluid. In other examples, the light source can utilize bright field imaging to illuminate the cell-containing fluid. Bright field imaging can allow for some cells in the specimen to appear dark when surrounded by the bright viewing field. In bright field imaging a cell may or may not be conjugated with a fluorescent molecule. Example illumination sources can include an infrared light source, near infrared light source, laser, light emitting diode, xenon arc lamp, mercury arc lamp, focused sunlight, halogen lamp, or the like.

In some examples, a wavelength of the electromagnetic energy entering the foyer can be correlated to the fluorescent molecule. For example, the illumination source can emit a wavelength tied to the fluorescent molecule. In another example, the correlation can occur by an illumination source which includes individual illuminators which can be selectively turned on/off. In other examples, a wavelength emitted by the illumination source can be emitted towards a filter cube, a spectral filter, a beam splitter, a reflective directional source such as a mirror, a prism, combinations thereof, or the like. In some examples, wavelengths of the illuminated light that do not correlate with the excitement energy for the fluorescent molecule can be filtered or directed away from the foyer of the cell-isolating dispenser. The illuminated light may be directed or focused using a mirror and/or an objective lens.

The detector 420 can measure or receive and pass along fluorescence information, for example. In one example, the detector can include a fluorimeter, a photoluminescence spectrometer, a semiconductor such as a p-n junction diode, a photodiode, a phototransistor, or a combination thereof. In yet other examples, the detector can be a detector array. The detector can be positioned to detect fluorescence from a cell conjugated with a fluorescence molecule. The detector can be a standalone component or can be integrated with the cell-isolating dispenser as described above. In yet other examples, the detector can be positioned on a linear substrate designed to be placed between a stage and a multi-well plate.

In some examples, the cell-isolating systems 400 can further include a stage 430 configured to accept a multi-well plate 440. The stage can be optically transparent to allow for positioning of the illumination source and/or detector below the stage. The stage and the cell-isolating dispenser can be movable in relation to one another. The movable component can be the stage, the cell-isolating dispenser, or a combination thereof. The movement can allow for the aligning of individual wells of a multi-well plate with the nozzle of the thermal ejector on the cell-isolating dispenser. The movement can also align a height of a multi-well plate with respect to the bottom of the nozzle of the cell-isolating dispenser. In some examples, the multi-well plate and the nozzle can be spaced apart at from 0.5 mm to 5 mm, from 1 mm to 4 mm, or from 1 mm to 3 mm. Minimizing a distance between the top of the multi-well plate and the nozzle can, in some instances, minimize sample loss from a misdirected or displaced droplet, e.g., being blown off course, during ejecting and depositing in a well of the multi-well plate. In some examples, the stage can be modified to permit movement of the illumination source, the detector, or a combination thereof, a corollary amount when the stage is moved. In some examples, the stage can include a coupling to allow for mounting of the illumination source, the detector, or a combination thereof.

The controller 450, in further detail, can include a microprocessor, a processing core, a field-programmable gate array, a central processing unit, a graphics processing unit, a machine recordable medium, any combinations thereof, or the like. The controller can cooperate with a memory to execute instructions and can include machine-readable storage encoded with executable instructions. The controller can be separate of the cell-isolating dispenser 100 or integrated as part of the cell-isolating dispenser and can have electrical connections to any or all of the various sensors on the cell-isolating dispenser, the thermal ejector 130 of the cell-isolating dispenser, the illumination source 410, the detector 420, the stage 430, or a combination thereof. The controller can control timing of the cell-containing fluid through the cell-isolating dispenser, cause the thermal ejector to expel fluid from the foyer though the nozzle 132, cause movement of the cell-isolating dispenser and/or the stage to align individual wells of a multi-well plate 440 with the nozzle of the thermal ejector 134, or set a vertical distance between a fluid in a multi-well plate and the nozzle of the thermal ejector.

In some examples, the controller 450 can receive feedback from sensors which can indicate whether or not a particle of interest or other particle in the cell-containing fluid has passed through the sensor in the cell-isolating dispenser 100. This determination can, for example, be based on the configuration of the cell-isolating dispenser. Depending on the sensors and measured data, the feedback can indicate an alignment of which well of the multi-well plate 440 a droplet may be ejected into. When feedback received indicates that a particle of interest, e.g., a desired cell, is present, then the controller can direct alignment of an empty well in the multi-well plate with the nozzle 132 of the cell-isolating dispenser. Following the alignment, the controller can direct the thermal ejector 130 to eject a droplet of the cell-containing fluid with the particle of interest therein into the empty well, thereby allowing individual wells of the multi-well plate to be filled with an individual cell of interest. When feedback received indicates that a particle of interest is not present, then the controller can direct alignment of a junk well in the multi-well plate with the nozzle of the cell-isolating dispenser. Following alignment of the junk well and the nozzle, the controller can direct the thermal ejector to eject a droplet of the cell-containing fluid into the junk well including droplets not of interest.

### Methods of Isolating and Sorting Individual Cells

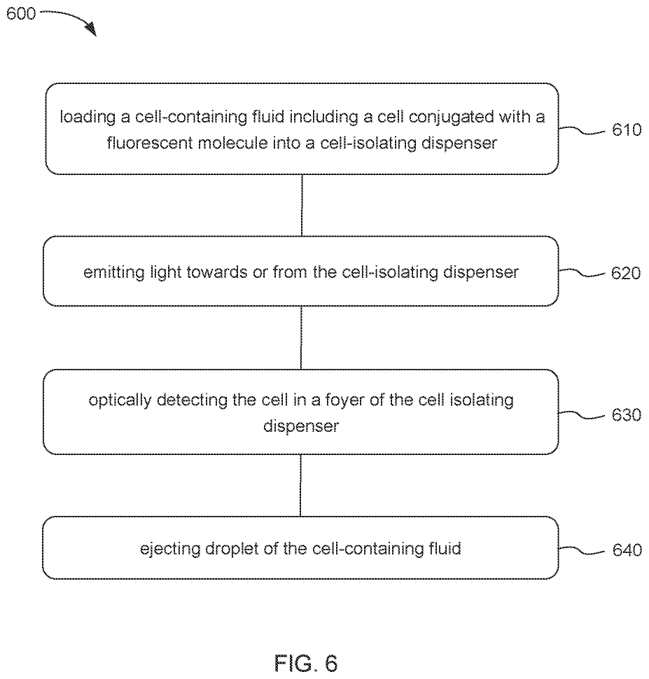

Methods 600 of isolating and sorting individual cells are shown by way of example in FIG. 6. In this example, the method can include loading 610 a cell-containing fluid including cells of interest into a cell-isolating dispenser; emitting 620 light towards the cell-isolating dispenser; optically detecting 630 the cell in the foyer based on emitted fluorescence or contrast through the optically transparent portion of the wall; and ejecting 640 the droplet of the cell-containing fluid including the cell that was detected from the nozzle of the thermal ejector into a multi-well plate. The cell-isolating dispenser can be as described above.

In some examples, methods can include evaluating whether or not a cell of interest is present in the cell-containing fluid during isolation of cells from the cell-containing fluid. For example, whenever a cell is detected based on a change as measured by a sensor, then in some examples, the droplet of the cell-containing fluid including a cell that has been detected either through fluorescing or contrast can be individually ejected into individual wells on the multi-well plate. In this example, any sensed cell can be ejected individually into an individual well on the multi-well plate. Once each cell is individually isolated in independent wells on the multi-well plate, then the method can further include determining a cell type of the cell that was detected in the individual wells on the multi-well plate. This determination can be done through fluorescence or other means.

In yet other examples, determination of whether or not a cell of interest is present in a biological sample can be done during the isolation. This can allow individual wells on the multi-well plate to be filled with cells of interest. A communal junk well can be used to dispose of cells and other biological components present in a biological sample that are not of interest. In order to determine whether or not a cell of interest is present, a measurement from the sensor can be evaluated with respect to a cell type. For example, an impedance sensor can generate different impedances based on the cell type that passes through the impedance sensor. A photoelectric sensor in connection with a fluorescent molecule can allow for a detection of different cell types. Multiple fluorescent molecules having different emission wavelengths can be designed to conjugate with a specific cell type. Therefore, detection of the various emission wavelengths from various fluorescent molecules can correlate with a cell type. Based on the florescence emission, the controller can determine whether to align a junk well or an empty well of the multi-well plate with the nozzle prior to ejection. In an example, a cell type of a fluorescing cell, a cell of interest bound to a fluorescing molecule which becomes excited by light and fluoresces, can be determined based on the emitted fluorescence through the optically transparent wall or portion thereof prior to ejection. In another example, the method can further include emitting fluorescing cells of interest into individual wells on the multi-well plate, and ejecting fluorescing cells that are not of interest into a communal junk well.

Upon isolation of a cell, the cell can be used for fluorescing biological assays. Examples of fluorescing biological assays can include nucleic acid micro-assays, bio-sensing assays, cell assays, PCR, drug delivery research, energy transfer-based assays, fluorescence in situ hybridization (FISH), fluorescent reporter assays, fluorescent spectroscopy, quantum dot detection of cancer markers/cells, detection of reaction oxygen species, detection of viral antigens, detection of pathogens, detection of toxins, chemi-fluorescent enzyme-linked immunosorbent assays (ELISA), and the like for example.

### Definitions

It is noted that, as used in this specification and the appended claims, the singular forms “a,” “an,” and “the” include plural referents unless the content clearly dictates otherwise.

As used herein, “ejecting” refers to the dispensing of the cell-containing fluid (and a single cell in many instances) from ejection or jetting architecture, such as thermal ink-jet architecture. Thermal ink-jet architecture can be configured to print varying drop sizes, such as droplets having a size from 15 μm to 50 μm, from 20 μm to 40 μm, or from 25 μm to 35 μm, for example. These droplet sizes correspond with droplet volumes of from 2 picoliters (pL) to 65 pL, from 5 pL to 25 pL, from 4 pL to 34 pL, from 25 pL to 50 pL, from 8 pL to 22 pL, or from 35 pL to 65 pL, respectively.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of 1 wt % to 20 wt % should be interpreted to include the explicitly recited limits of 1 wt % and 20 wt % and to include individual weights such as 2 wt %, 11 wt %, 14 wt %, and sub-ranges such as 10 wt % to 20 wt %, 5 wt % to 15 wt %, etc.

1. A cell-isolating dispenser, comprising:
a fluid reservoir;
a foyer fluidically coupled to the fluid reservoir via a fluid outlet, the foyer to receive a cell-containing fluid from the fluid reservoir, wherein a wall or portion of the wall of the foyer is optically transparent; and
a thermal ejector fluidically coupled to the foyer to receive the cell-containing fluid from the foyer and thermally eject a droplet of the cell-containing fluid through a nozzle via a thermal actuator.

2. The cell-isolating dispenser of claim 1, wherein the wall or portion of the wall that is optically transparent forms a collimating lens or has a collimating lens attached thereto.

3. The cell-isolating dispenser of claim 2, wherein the collimating lens is refractive, Fresnel, or diffractive.

4. The cell-isolating dispenser of claim 1, wherein an opposing wall of the foyer comprises an optical detector.

5. The cell-isolating dispenser of claim 4, wherein the optical detector includes band pass filter and p-n junction diode.

6. The cell-isolating dispenser of claim 1, further comprising an impedance sensor to measure impedance and monitor passage of a cell in the cell-containing fluid through the cell-isolating dispenser.

7. The cell-isolating dispenser of claim 6, wherein the fluid outlet includes a constricted region and the impedance sensor is positioned to measure impedance at the constricted region.

8. The cell-isolating dispenser of claim 1, wherein the nozzle is sized to eject the droplet of the cell-containing fluid at a size from 15 μm to 50 μm.

9. A cell-isolating system, comprising:
a cell-isolating dispenser including:
a fluid reservoir,
a foyer fluidically coupled to the fluid reservoir via a fluid outlet, the foyer to receive a cell-containing fluid from the fluid reservoir, wherein a wall or portion of the wall of the foyer is optically transparent, and
a thermal ejector fluidically coupled to the foyer to receive the cell-containing fluid from the foyer and thermally eject a droplet of the cell-containing fluid through a nozzle via a thermal actuator;
an illumination source to emit light towards the wall or portion of the wall that is optically transparent; and
a detector to detect fluorescence emitted from a fluorescent molecule conjugated with a cell in the cell-containing fluid.

10. The cell-isolating system of claim 9, further comprising an optical filter, beam splitter, mirror, or a prism to isolate and direct filtered wavelengths of light.

11. The cell-isolating system of claim 9, further comprising a stage configured to accept a multi-well plate, wherein the stage and the cell-isolating dispenser are movable in relation to one another in order to align individual wells of a well plate with the nozzle of the thermal ejector.

12. The cell-isolating system of claim 9, wherein the system further includes a controller to:
expel fluid from the foyer though the nozzle,
align individual wells of a well plate with the nozzle of the thermal ejector,
set a vertical distance between a fluid in a multi-well plate and the nozzle of the thermal ejector, or
a combination thereof.

13. A method of isolating and sorting individual cells, comprising:
loading a cell-containing fluid including a cell conjugated with a fluorescent molecule into a cell-isolating dispenser, including:
a fluid reservoir,
a foyer fluidically coupled to the fluid reservoir via a fluid outlet, the foyer to receive a cell-containing fluid from the fluid reservoir, wherein a wall or portion of the wall of the foyer is optically transparent, and
a thermal ejector fluidically coupled to the foyer to receive the cell-containing fluid from the foyer and thermally eject a droplet of the cell-containing fluid through a nozzle via a thermal actuator;
emitting light towards or from the cell-isolating dispenser;
optically detecting the cell in the foyer based on emitted fluorescence or contrast through the wall or portion of the wall that is optically transparent; and
ejecting the droplet of the cell-containing fluid including the cell from the nozzle of the thermal ejector into a multi-well plate.

14. The method of isolating and sorting individual cells of claim 13, wherein the droplet of the cell-containing fluid including a cell is individually ejected into individual wells on the multi-well plate, and wherein the method further comprises determining a cell type of the cell in the individual wells on the multi-well plate.

15. The method of isolating and sorting individual cells of claim 13, wherein a cell type of a fluorescing cell is determined based on the emitted fluorescence through the wall or portion of the wall that is optically transparent, and wherein the method further comprises emitting fluorescing cells of interest into individual wells on the multi-well plate, and wherein fluorescing cells that are not of interest are ejected into a communal junk well.
